(19) United States
(12) Patent Application Publication
(10) Pub. No.: US 2011/0136605 A1
(43) Pub. Date: Jun. 9, 2011

(54) DUAL PLUNGER LINEAR CHAIN TENSIONER FOR TENSIONING MULTIPLE CHAIN SPANS

(75) Inventors: Aaron Brechko, Rochester, NY (US); Simon Xunnan He, Troy, MI (US)

(73) Assignee: Schaeffler Technologies GmbH & CO. KG, Herzogenaurach (DE)

(21) Appl. No.: 12/941,295

(22) Filed: Nov. 8, 2010

Related U.S. Application Data
(60) Provisional application No. 61/266,232, filed on Dec. 3, 2009.

(51) Int. Cl. F16H 7/08

(52) U.S. Cl. 474/111

(57) ABSTRACT

A chain tensioner is provided with a base housing, a first plunger, and a second plunger. The base housing surrounds a portion of at least one of the first or second plungers. A first spring is disposed between the first and second plungers, and a second spring is disposed between the first plunger and the base housing. The chain tensioner can tension two chain spans simultaneously with different stiffness parameters based on the two springs.

### CROSS-REFERENCE TO RELATED APPLICATIONS

This application claims the benefit of U.S. Provisional Application No. 61/266,232, filed Dec. 3, 2009, which is incorporated herein by reference as if fully set forth.

### FIELD OF INVENTION

This application is generally related to chain tensioners and more particularly related to dual plunger chain tensioners for tensioning multiple chain spans.

### BACKGROUND

Chain drives are often used in internal combustion engines, for example as a timing chain, as well as other systems to transmit power. Such chain drive systems experience both tight and slack chain spans during operation based on the span being pulled towards or advancing away from the driving sprocket, which can lead to adverse chain system dynamics. To reduce these adverse effects, it has been known to use mechanical chain tensioners and guides to provide tension to selected chain spans. Some known mechanical chain tensioners use a single spring acting on a single plunger, which is connected to or contacts a tensioning shoe, to tension a single span of the chain. However, in such an arrangement, multiple chain tensioner assemblies are required to tension additional spans of the chain on a chain drive, which results in higher costs and additional space requirements. Additionally, each chain tensioner assembly includes only a single spring, thus limiting the assembly to one stiffness parameter for tensioning the chain drive system. Therefore, a need exists for a chain tensioner that can simultaneously provide tension to multiple spans of a chain drive and more efficiently eliminate adverse chain system dynamics.

### SUMMARY

A chain tensioner is disclosed having a base housing, a first plunger, and a second plunger. The base housing surrounds a portion of at least one of the first or second plungers. A first spring is disposed between the first plunger and the second plunger and a second spring is disposed between the first plunger and the base housing.

In other embodiments of the chain tensioner, a shaft portion of the first plunger may be hollow and arranged concentrically about a shaft portion of the second plunger, with the second spring arranged concentrically about the first spring. The first and second spring may have different spring constants. Additionally, the chain tensioner may include first and second shoes affixed to or pivotally mounted in proximity to the first and second plungers, respectively. The first and second plungers are arranged to contact and outwardly bias the first and second shoes during operation. For sake of brevity, this summary does not list all aspects of the present device, which is described in further detail below.

### BRIEF DESCRIPTION OF THE DRAWINGS

The foregoing summary, as well as the following detailed description of the preferred embodiments of the invention will be better understood when read in conjunction with the appended drawings. For the purpose of illustrating the invention, there is shown in the drawings embodiments which are presently preferred. It should be understood, however, that the invention is not limited to the precise arrangement shown.

FIG. 1 is a front elevational view of an embodiment of the chain tensioner.

FIG. 2 is a cross-sectional view of the chain tensioner shown in FIG. 1.

FIG. 3 is a perspective view of a plunger assembly of the chain tensioner shown in FIG. 1.

FIG. 4 is a cross-sectional view of the chain tensioner shown in FIG. 1 taken along line 4-4 of FIG. 5.

FIG. 5 is a perspective view of the chain tensioner shown in FIG. 1.

FIG. 6 is a cross-sectional view of the chain tensioner shown in FIG. 1 taken along line 6-6 of FIG. 5.

FIG. 7 is a front elevational view of another embodiment of the chain tensioner.

FIG. 8 is a fragmentary cross-sectional view of the chain tensioner shown in FIG. 7.

### DETAILED DESCRIPTION OF THE PREFERRED EMBODIMENTS

Certain terminology is used in the following description for convenience only and is not limiting. The words “outer” and “outwardly” refer to a direction away from the parts referenced in the drawings. A reference to a list of items that are cited as “at least one of a, b, or c” (where a, b, and c represent the items being listed) means any single one of the items a, b, or c, or combinations thereof. The terminology includes the words specifically noted above, derivatives thereof, and words of similar import.

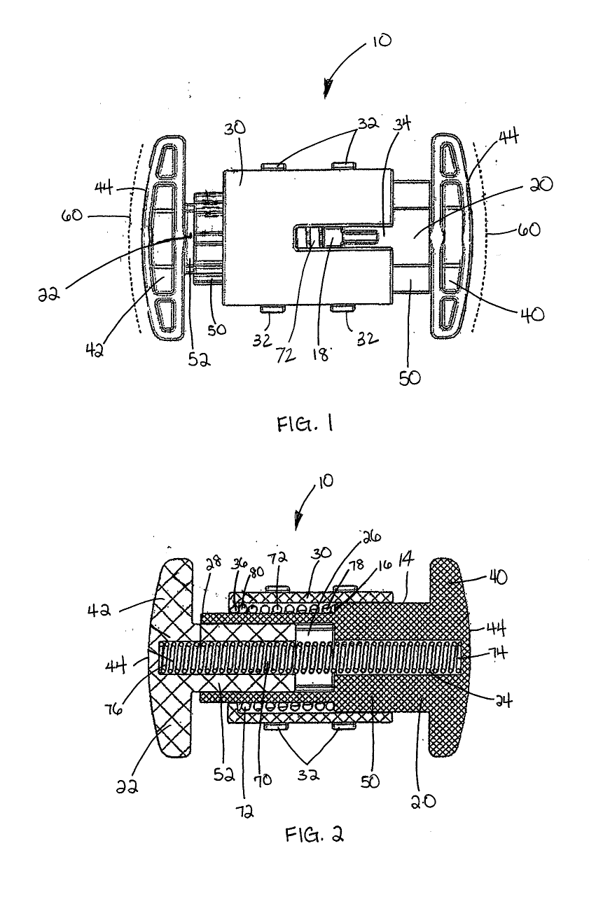

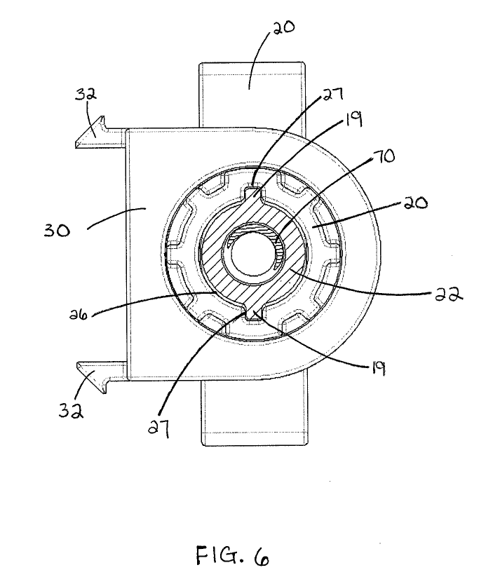

FIGS. 1-6 show one embodiment of the chain tensioner 10 according to the present invention. As used herewithin, the term “chain tensioner” refers to a tensioner used in a chain drive, which may utilize a typical mechanical chain running on sprockets or, alternatively, a toothed belt running on toothed pulleys. As shown in FIGS. 1-6, the chain tensioner 10 includes a first plunger 20 and a second plunger 22. The first and second plungers 20, 22 may be made of any suitable material, such as metal or plastic, through a variety of methods. A base housing 30 surrounds a portion of the first and second plungers 20, 22. Alternatively, the base housing 30 may be arranged to surround a portion of only the first plunger 20 or only the second plunger 22. The base housing 30 may be formed from metal or a polymeric material, and can be formed by casting, punching, injection molding, or any other suitable means. The base housing 30 may include mounting elements 32, which may be formed as clips suitable for a snap connection. Alternatively, screws, bolts, or any other suitable component for securing the base housing 30 to a fixed location at or adjacent to a chain drive may be used.

As shown in FIG. 2, a first spring 70 is disposed between the first plunger 20 and the second plunger 22, while a second spring 72 is disposed between the first plunger 20 and the base housing 30.

The first plunger 20 may include a shoe portion 40 and a shaft portion 50; the second plunger 22 may also include a shoe portion 42 and a shaft portion 52. The shaft portion 50 of the first plunger 20 is preferably hollow and arranged concentrically about the shaft portion 52 of the second plunger 22. Likewise, the second spring 72 may be arranged concentrically about the first spring 70. The first and second plungers 20, 22 may be arranged coaxially, with the shoe portion 40 of the first plunger 20 facing in an opposite direction from the shoe portion 42 of the second plunger 22. The shoe portions 40, 42 may be formed integrally with or separately from the shaft portions 50, 52 of the first and second plungers 20, 22. The shoe portions 40, 42 may be made from any suitable material, such as a molded polymeric material which may include chopped fibers incorporated within. As shown in FIG. 1, each of the shoe portions 40, 42 of the first and second plungers 20, 22 may have an outer surface 44 that forms a chain running path for a chain 60 of a chain drive. The outer surface 44 of the shoe portions 40, 42 may include a TEFLON® coating, and may be formed as a separate part from the shoe portions 40, 42. Optionally, the first plunger 20 may include an anti-rotation device 18 that slides within a corresponding slot 34 in the base housing 30 to prevent the first plunger 20 from rotating within the base housing 30. Rotation of the first plunger 20 can also be prevented by other arrangements, such as by forming one or more protrusions on the shaft portion 50 of the first plunger 20 that correspond to one or more grooves on an inner surface of the base housing 30. As illustrated in FIG. 6, the second plunger 22 may also include an anti-rotation device 19 to prevent the second plunger 22 from rotating within the first plunger 20. The anti-rotation device 19 of the second plunger 22 may take the form of at least one protrusion on the shaft portion 52 of the second plunger 22 that corresponds to at least one groove 27 on an inner surface of a cavity 26 of the first plunger 20.

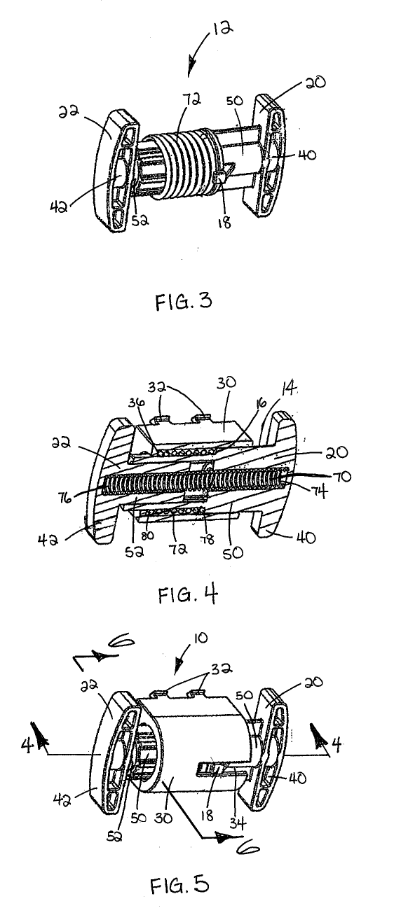

During operation of the chain tensioner 10, the shaft portion 50 of the first plunger 20 slides within a corresponding opening or slot in the base housing 30 and the shaft portion 52 of the second plunger 22 slides within the hollow shaft portion 50 of the first plunger 20. Contact surfaces of the base housing 30 and the shaft portions 50, 52 of the first and second plungers 20, 22 may include an anti-friction coating, which can be made of any substance having the desired properties. As shown in FIGS. 2 and 4, the first plunger 20 is preferably formed with a first cavity 24 that receives a first end 74 of the first spring 70 and a second cavity 26 that receives the shaft portion 52 of the second plunger 22. The second plunger 22 is preferably formed with a cavity 28 that receives a second end 76 of the first spring 70. The first plunger 20 preferably includes an outer surface 14 having a shoulder 16 that supports a first end 78 of the second spring 72, and the base housing 30 preferably includes a lip 36 that supports a second end 80 of the second spring 72. Together, the first plunger 20, second plunger 22, first spring 70, and second spring 72 form the plunger assembly 12 illustrated in FIG. 3.

The present chain tensioner 10 with first and second plungers 20, 22 and first and second springs 70, 72 allows simultaneous tensioning of different chain spans of a chain drive while minimizing mounting space and components. Additionally, the first spring 70 may have a spring constant k1 that is different from a spring constant k2 of the second spring 72. For example k1=2−10 N/mm and k2=0.5−5 N/mm. The presence of two different springs 70, 72 provides an additional stiffness parameter to the chain tensioner assembly 10 and allows the first and second plungers 20, 22 to either move as a unit or independently with respect to the base housing 30. This arrangement applies desired tension to multiple spans of the chain while more efficiently eliminating adverse dynamics in the chain drive system. In place of first and second springs 70, 72, a pressurized hydraulic medium can be used to bias the first and second plungers 20, 22 and provide tension to the chain drive. However, such an arrangement would require independent pressurized fluid supplies.

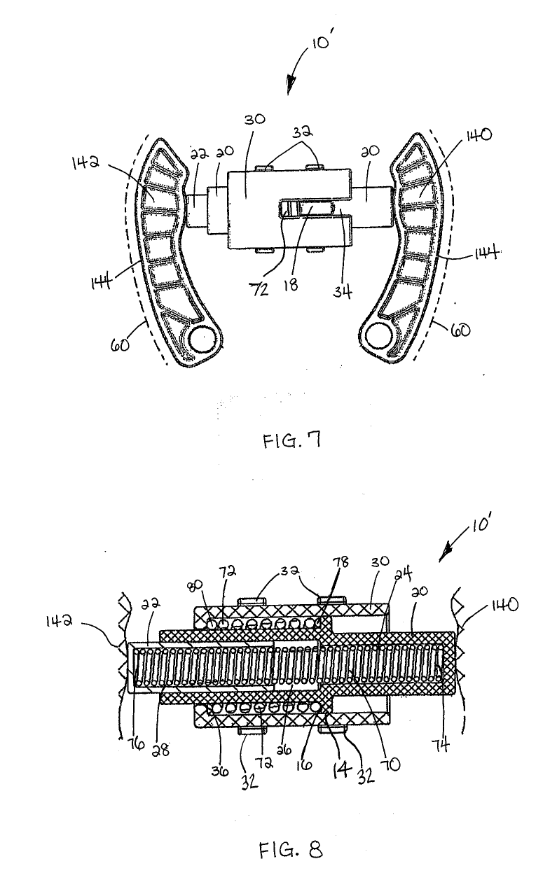

In an alternate embodiment of the present chain tensioner 10′, as shown in FIGS. 7-8, the chain tensioner 10′ includes the first and second plungers 20, 22, the base housing 30 surrounding a portion of at least one of the first or second plungers 20, 22, the first spring 70 disposed between the first and second plungers 20, 22, and the second spring 72 disposed between the first plunger 20 and the base housing 30. In addition, a first tensioning shoe 140 and a second tensioning shoe 142 are pivotally mounted to an engine block or other support surface in proximity to the first and second plungers 20, 22, respectively. The first and second plungers 20, 22 are arranged to contact and outwardly bias the first and second tensioning shoes 140, 142 during operation of the chain tensioner 10′.

As shown in FIG. 8, the first and second plungers 20, 22 and first and second springs 70, 72 of the alternate embodiment of the chain tensioner 10′ may be arranged in a similar manner to that described above with respect to FIGS. 1-6, such that the first and second tensioning shoes 140, 142 face in opposite directions from each other. The first plunger 20 is preferably formed with a first cavity 24 that receives a first end 74 of the first spring 70 and a connected second cavity 26 that receives the second plunger 22. The second plunger 22 is preferably formed with a cavity 28 that receives a second end 76 of the first spring 70. The first plunger 20 is preferably arranged concentrically about the second plunger 22, with the second spring 72 arranged concentrically about the first spring 70. The first plunger 20 preferably includes an outer surface 14 with a shoulder 16 that supports a first end 78 of the second spring 72, and the base housing 30 preferably includes a lip 36 that supports a second end 80 of the second spring 72. During operation of the chain tensioner 10′, the first plunger 20 slides within the base housing 30 while the second plunger 22 slides within the first plunger 20, with the first and second springs 70, 72 providing stiffness parameters to the assembly.

The first and second tensioning shoes 140, 142 may be made through a variety of methods from any suitable material, such as metal, a molded polymeric material with chopped fibers incorporated within, or other composite materials. As shown in FIG. 7, each of the first and second tensioning shoes 140, 142 may have an outer surface 144 that forms a chain running path for a chain 60 of a chain drive. The outer surface 144 of the first and second tensioning shoes 140, 142 may include an anti-friction and/or wear resistant coating, such as TEFLON®, and may be formed as a separate part from the tensioning shoes 140, 142.

The chain tensioner 10′ according to the alternate embodiment may include other features described above with respect to FIGS. 1-6, such as an anti-rotation device 18 on the first plunger 20 that slides within a corresponding slot 34 in the base housing 30 to prevent the first plunger 20 from rotating within the base housing 30. The second plunger 22 may also include an anti-rotation device 19 to prevent the second plunger 22 from rotating within the first plunger 20. The base housing 30 can also include mounting elements 32, and the first and second springs 70, 72 may have different spring constants to provide desired stiffness parameters to the chain tensioner 10′.

Having thus described various embodiments of the present chain tensioner in detail, it is to be appreciated and will be apparent to those skilled in the art that many physical changes, only a few of which are exemplified in the detailed description above, could be made in the apparatus without altering the inventive concepts and principles embodied therein. The present embodiments are therefore to be considered in all respects as illustrative and not restrictive, the scope of the invention being indicated by the appended claims rather than by the foregoing description, and all changes which come within the meaning and range of equivalency of the claims are therefore to be embraced therein.

What is claimed is:

1. A chain tensioner comprising:
a base housing;
a first plunger and a second plunger, with the base housing surrounding a portion of at least one of the first or second plungers;
a first spring disposed between the first plunger and the second plunger; and
a second spring disposed between the first plunger and the base housing.

2. The chain tensioner of claim 1, wherein the first plunger has a first cavity that receives a first end of the first spring and a second cavity that receives a shaft portion of the second plunger, and the second plunger has a cavity that receives a second end of the first spring.

3. The chain tensioner of claim 1, wherein each of the first and second plungers has a shoe portion and a shaft portion, the first and second plungers are arranged coaxially, with the shoe portion of the first plunger facing in an opposite direction from the shoe portion of the second plunger.

4. The chain tensioner of claim 3, wherein the shaft portion of the first plunger is hollow and arranged concentrically about the shaft portion of the second plunger, and the second spring is arranged concentrically about the first spring.

5. The chain tensioner of claim 4, wherein the shaft portion of the first plunger slides within a slot or opening of the base housing and the shaft portion of the second plunger slides within the hollow shaft portion of the first plunger.

6. The chain tensioner of claim 3, wherein each of the shoe portions has an outer surface that forms a chain running path.

7. The chain tensioner of claim 3, wherein the shoe portions of the first and second plungers are formed integrally with the shaft portions of the first and second plungers, respectively.

8. The chain tensioner of claim 1, wherein the first plunger has an outer surface having a shoulder that supports a first end of the second spring, and the base housing has a lip that supports a second end of the second spring.

9. The chain tensioner of claim 1, wherein the base housing has a mounting element.

10. The chain tensioner of claim 1, wherein the first spring has a spring constant that is different from a spring constant of the second spring.

11. The chain tensioner of claim 1, further comprising first and second tensioning shoes pivotally mounted in proximity to the first and second plungers, respectively, and the first and second plungers being arranged to contact and outwardly bias the first and second tensioning shoes.

12. The chain tensioner of claim 1, wherein the first plunger includes an anti-rotation device that slides within a corresponding slot in the base housing to prevent the first plunger from rotating within the base housing.

13. The chain tensioner of claim 12, wherein the second plunger includes an anti-rotation device that corresponds to an inner surface of a cavity of the first plunger to prevent the second plunger from rotating within the first plunger.
